(19) United States
(12) Patent Application Publication
(10) Pub. No.: US 2023/0139451 A1
(43) Pub. Date: May 4, 2023

(54) MOVEABLE SHADING DEVICES AND METHODS OF USE

(71) Applicant: The Regents of the University of Colorado, a body corporate, Denver, CO (US)

(72) Inventor: Moncef Krarti, Longmont, CO (US)

(21) Appl. No.: 17/951,504

(22) Filed: Sep. 23, 2022

Related U.S. Application Data
(60) Provisional application No. 63/247,530, filed on Sep. 23, 2021.

(51) Int. Cl. E06B 9/38

(52) U.S. Cl. CPC E06B 9/38; E06B 2009/2476

(57) ABSTRACT

Systems and methods of use of movable shading devices configured to conserve energy usage associated with the building or house as described herein. An example shade system includes at least one moveable shade that is moveable in position about one or more of a lateral axis, vertical axis, and rotational axis with respect to a window of the building or house, where the at least one moveable shade is external to or internal to the window, and a programmable controller configured to selectively control movement of the at least one moveable shade about the lateral axis, vertical axis, and/or rotational axis, where the at least one moveable shade is selectively moveable to regulate conditions of the building or house based at least on one or more of incoming radiation, temperature, season, and time of day.

### CROSS-REFERENCE TO RELATED APPLICATIONS

This application claims the benefit of U.S. provisional patent application No. 63/247,530, filed on Sep. 23, 2021, and titled “MOVABLE SHADING DEVICES AND METHODS OF USE,” the disclosure of which is expressly incorporated herein by reference in its entirety.

### BACKGROUND

Significant portions of the total US electricity use and natural gas demand are consumed by residential buildings. In particular, space heating and cooling make up more than half of the annual energy use of US residential sector. Heat losses and gains from the envelope contribute substantially to the heating and cooling energy needs of residential buildings.

In the US, buildings consume approximately 39% of total primary energy use with heating and cooling equipment accounting for a significant portion of this energy needed to maintain indoor thermal comfort. It is estimated that windows are responsible directly for 10% of energy use in buildings and affect indirectly other end-uses such heating, cooling lighting, fans, and pumps which account for 40% of total US buildings' energy consumption. Specifically, windows can affect thermal performance of buildings through several mechanisms heat transmission (i.e., conduction and convection through the glazing layers), air infiltration (i.e., uncontrolled airflow through cracks around the windows' frames), and solar heat gains (i.e., solar radiation transmitted through the transparent glazing). In addition, windows affect natural light aperture and consequently the use of electrical lighting based on daylighting controls. Significant efforts have been made to improve the energy performance of windows using thin triple or vacuum-insulated glazing, high-performing inert gas fills, insulating frames, switchable or dynamic glazing. While high performance windows can be implemented in new constructions, the replacement of existing windows are generally expensive and not cost-effective.

Movable shading devices may enhance the energy performance and indoor visual comfort for both existing and new windows. Movable PV integrated shading devices (MPVISDs) can offer the additional benefit of converting solar radiation, otherwise wasted, to electricity that can be used on-site and hence help mitigating CO₂ emissions. Also, optimized controls for movable PV-integrated shading devices (MPVISDs) may minimize thermal loads and maximize electricity generation.

The shades described herein can improve the energy efficiency as well as provide on-site PV electricity generation for existing and new housing units with no access to roofs. Various design configurations and control strategies are considered in the analysis to illustrate the flexibility of implementing the PV-integrated dynamic shades to both existing and new housing units. Through optimization of both the energy efficiency and renewable energy benefits, the performance of PV-integrated dynamic shades was investigated under various operating and design conditions. The results of the analysis indicate that the dynamic shades when integrated with PV panels and optimally operated achieve significant reductions in annual energy demands for the housing units especially when located in hot and mild climates. In particular, the PV-integrated shades when optimally operated can reduce the annual energy consumption for a housing unit located in San Francisco, Calif., by over 80% with window-to-wall ratio of 30% and double-pane Low-E glazing. Even higher savings can be achieved for housing units with single pane glazing and larger windows.

It is with respect to these and other considerations that certain embodiments of the present disclosure are presented.

### SUMMARY

In the present application, according to some embodiments, a system including movable shading devices, configured to cover at least some of a window or windows of a building to conserve energy usage associated with the building or house are presented. In various embodiments implementations, tiltable photovoltaic panels are included on the movable shading devices. In various embodiments implementations, a programmable controller can be used to control the movable shading devices and/or the tiltable photovoltaic panels. In other aspects, the present disclosure provides methods for conserving thermal energy using a system having one or more of the components described above and in the following detailed description.

In one aspect, the present disclosure relates to a shade system for a building or house. In one or more embodiments, the system includes at least one moveable shade that is moveable in position about one or more of a lateral axis, vertical axis, and rotational axis with respect to a window of the building or house, where the at least one moveable shade is external to or internal to the window, and a programmable controller configured to selectively control movement of the at least one moveable shade about the lateral axis, vertical axis, and/or rotational axis, where the at least one moveable shade is selectively moveable to regulate conditions of the building or house based at least on one or more of incoming radiation, temperature, season, and time of day. In one or more embodiments, the regulated conditions of the building or house include at least one of temperature and energy usage of the building or house.

In one or more embodiments, the at least one moveable shade is selectively moveable along the vertical axis of the window of the building or house.

In one or more embodiments, the at least one moveable shade is selectively moveable in the lateral axis along rails positioned at or on the respective window.

In one or more embodiments, the at least one moveable shade is selectively rotatable about the rotation axis such that the angular position of a rotatable panel portion, relative to the window, has a non-zero angular orientation and a non-zero tilt angle.

In one or more embodiments, the at least one moveable shade includes at least one rotatable panel portion.

In one or more embodiments, the rotatable panel portion includes one or more photovoltaic elements.

In one or more embodiments, the rotatable panel portion is configured as an overhang.

In one or more embodiments, the at least one moveable shade includes one or more layers of insulation.

In one or more embodiments, the at least one moveable shade includes at least two moveable shades, the at least two moveable shades comprising a first moveable shade and a second moveable shade, and where the first moveable shade and the second moveable shade are selectively moveable along at least the lateral axis with respect to one another such that the first moveable shade and the second moveable shade cover some or all of the window.

In one or more embodiments, the programmable controller is configured to selectively move the first moveable shade and second moveable shade.

In another aspect, the present disclosure relates to a method of shading at least part of a building or house. In one or more embodiments, the method includes the steps of selectively moving, using a programmable controller, the position of at least one moveable shade along one or more of a lateral axis, vertical axis, and rotational axis with respect to a window of the building or house, to regulate conditions of the building or house based on at least one of incoming radiation, temperature, season, and time of day.

In one or more embodiments, the method includes selectively moving, using the programmable controller, the at least one moveable shade along the vertical axis of the window of the building or house.

In one or more embodiments, the method further includes selectively moving, using the programmable controller, the at least one moveable shade to rotate about the rotational axis such that the angular position of a rotatable panel portion, relative to the window, has a non-zero angular orientation and non-zero tilt angle.

In one or more embodiments, the at least one moveable shade includes at least one panel portion comprising at least one photovoltaic element.

In one or more embodiments, the at least one moveable shade includes at least one panel portion comprising one or more layers of insulation.

In one or more embodiments, the regulated conditions of the building or house include at least one of temperature and energy usage of the building or house.

In one or more embodiments, the at least one moveable shade includes at least two moveable shades, the at least two moveable shades comprising a first moveable shade and a second moveable shade, and where the first moveable shade and the second moveable shade are selectively moveable, using the programmable controller.

In one or more embodiments, the method further includes changing, using the programmable controller, at least the vertical position and the rotation angle of the at least one moveable shade.

Other aspects and features according to example embodiments of the present disclosure will become apparent to those of ordinary skill in the art, upon reviewing the following detailed description in conjunction with the accompanying figures.

### BRIEF DESCRIPTION OF THE DRAWINGS

The accompanying figures, which are not necessarily drawn to scale, and which are incorporated in and constitute a part of this specification, illustrate several aspects described below.

FIG. 1 illustrates a method of operating movable shades according to one embodiment of the present disclosure.

FIG. 2 illustrates an insulated shading system with horizontally sliding rails.

FIGS. 3A-B illustrate configurations of PV (photovoltaic) panels incorporated into movable shades, according to some embodiments of the present disclosure. FIG. 3A illustrates a PV-integrated shading system with horizontally sliding panels. FIG. 3B illustrates a PV-integrated shading system with rotating PV panels.

FIGS. 4A-D illustrate examples of possible placements of movable shading systems using rails. FIG. 4A illustrates a shading system attached to the outside wall surface. FIG. 4B illustrates a shading system attached to a rail inserted within the wall in front of the window. FIG. 4C illustrates a shading system attached to a rail inside the wall surface. FIG. 4D illustrates a shading system attached to a rail inserted in the back of the window.

FIGS. 5A-5C illustrate examples of one-axis rotation positions for an adjustable photovoltaic shade in accordance with one or more embodiments of the present disclosure. FIG. 5A illustrates a deployment on top of a roof. FIG. 5B illustrates a half-shade deployment. FIG. 5C illustrates a full shade deployment.

FIGS. 6A-6D illustrate different positions of a PV-integrated sliding shade on a model housing unit window, according to one embodiment of the present disclosure. The static tilt angle of the PV-integrated sliding shade illustrated is 45 degrees.

FIG. 7 illustrates a model for shading effects of a top-floor PV-integrated shade on lower floor housing units HVAC demand and PV electricity production, according to one embodiment of the present disclosure.

FIG. 8 is diagram illustrating a computer hardware architecture for a computing system capable of implementing one or more embodiments.

### DETAILED DESCRIPTION

Although example embodiments of the present disclosure are explained in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Certain values may be expressed in terms of ranges “from” one value “to” another value. When a range is expressed in terms of “from” a particular lower value “to” a particular higher value, or “from” a particular higher value “to” a particular lower value, the range includes the particular lower value and the particular higher value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more components in a device or system does not preclude the presence of additional components or intervening components between those components expressly identified.

Various aspects of the present disclosure may be still more fully understood from descriptions of some example implementations and corresponding results. Some experimental data are presented herein for purposes of illustration and should not be construed as limiting the scope of the disclosed technology in any way or excluding any alternative or additional embodiments.

Throughout the present disclosure, the following abbreviations may be used to refer to describe aspects of the present disclosure:

COP: Coefficient of Performance for Heating Mode Operation of a Heat Pump

DBEM: Distinct Building Energy Model

EER: Energy Efficiency Ratio for Cooling Mode Operation of a Heat Pump [Btu/W]

HVAC: Heating, Ventilation, and Air Conditioning

PBM: Parametric Building Model

R-value: Thermal Resistance in IP Unit [hr.° F.ft²/Btu]

RSI: Thermal resistance in SI Unit [° C.m²/W]

WWR: Window-to-Wall Ratio

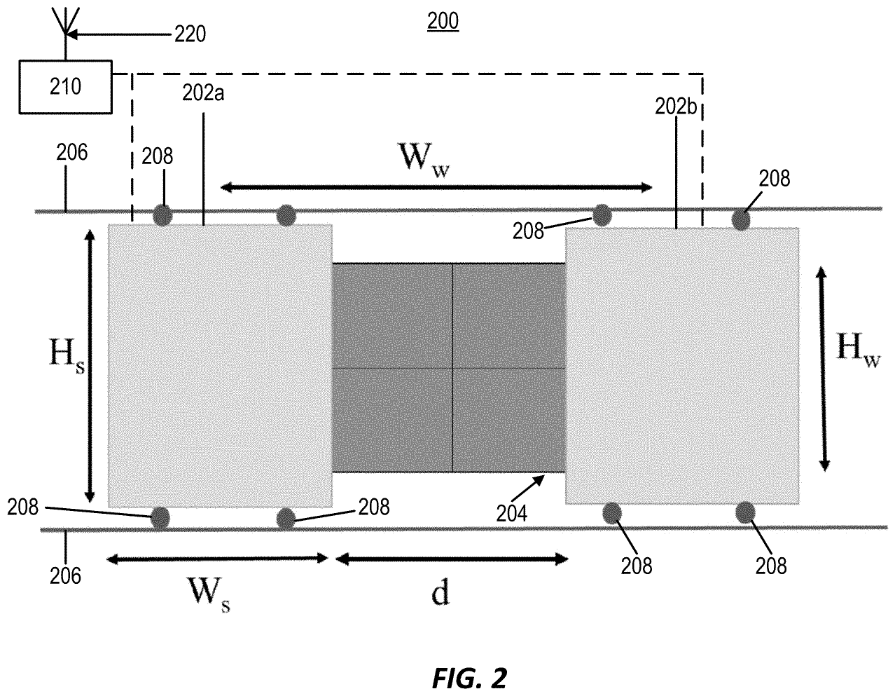

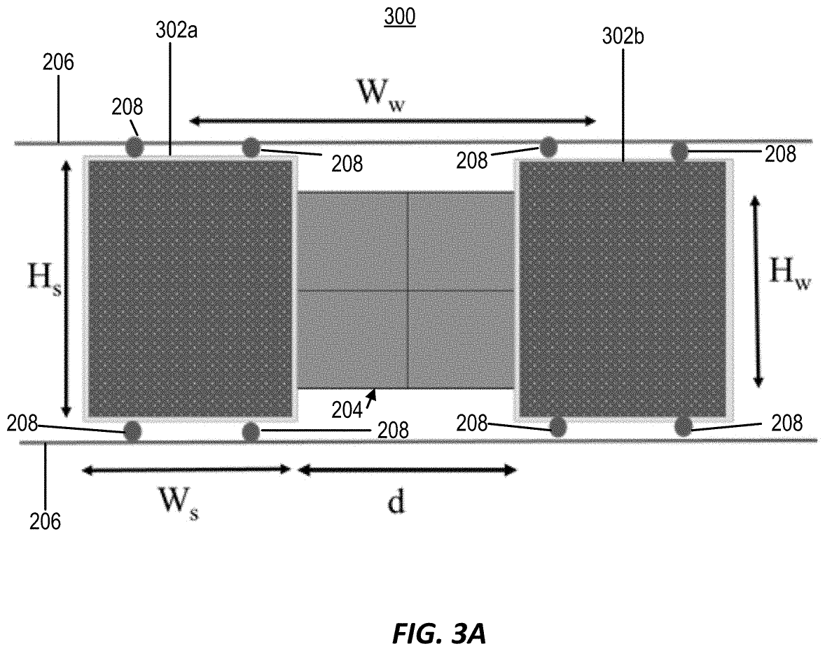

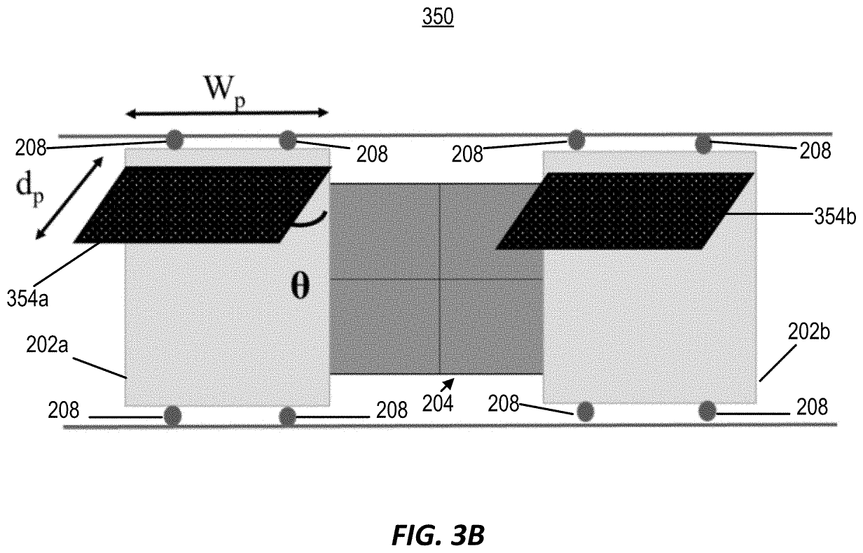

d: Distance between two shading panels [Refer to FIGS. 2, 3A] [m]

dp: Depth of PV a panel [Refer to FIG. 3B] [m]

dt: Depth of PV panels located on the top floor [m]

Hs: Height of a shading panel [Refer to FIGS. 2, 3A] [m]

H_{w}: Height of a window [Refer to FIGS. 2, 3A] [m]

Wp: Width of a PV panel [Refer to FIG. 3B]

[m] Wₛ: Width of shading panel [Refer to FIGS. 2, 3A] [m]

w_{w}: Width of window [Refer to FIGS. 2, 3A] [m]

θ: Tilt angle position of the PV panels [Refer to FIG. 3B] [degrees]

θt: Tilt angle position of the PV panels located on the top floor [degrees]

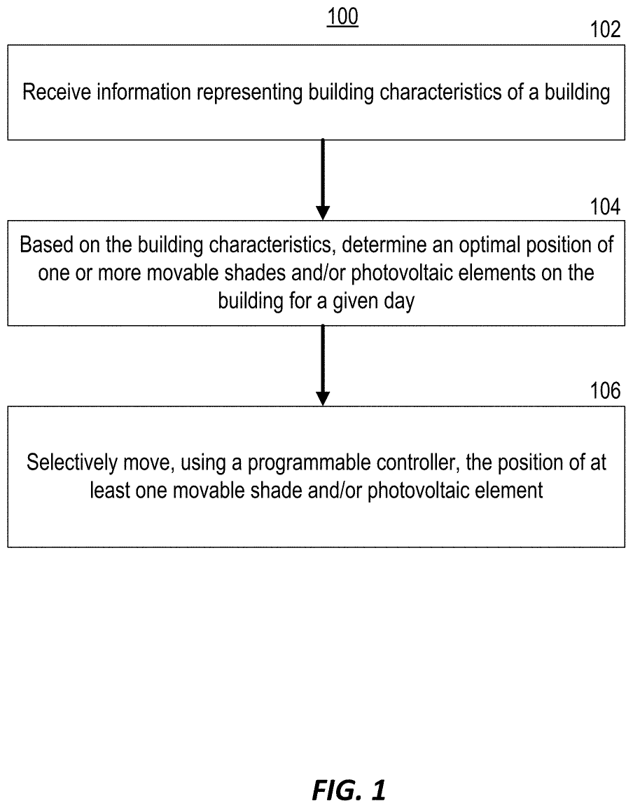

In one aspect, the present disclosure generally relates to movable shades, and control systems for movable shades. A non-limiting example method 100 for controlling the movable shades described herein is shown in FIG. 1. The system can receive 102 information representing building characteristics. Based on the building characteristics and outdoor weather conditions, the system can determine 104 an optimal position of one or more movable shades and/or PV panels on the building for a given month, day, and hour. At step 106, the system can selectively move 106 the shade positions and/or PV panel positions based on the optimal position determined 104. Selectively moving the movable shade can include moving the shade in one or more of a lateral axis, vertical axis, or rotational axis with respect to the surface that the movable shade is positioned on. For example, the movable shade can be positioned to shade a window, a roof, or a wall of a building (e.g., a house or office). If the movable shade is positioned to shade a window, the vertical axis can be defined as an axis running from the top to the bottom of the window, the lateral axis can be defined as the axis orthogonal to the vertical axis, and parallel to the surface of the window, and the rotational axis can be defined as any axis of rotation that changes the angle between the plane of the movable shade and the plane of a surface of the building (e.g., a wall or window of the building).

In some embodiments of the present disclosure, the movable shades are insulated shades. For example, the shades can include one or more layers of thermal insulation, or the shade can be formed partially or completely of thermally insulating materials.

It should be understood that throughout the present disclosure “optimal” or “optimization” can refer to different types of position that is determined 104, and is not limited to a single optimization or a single position. As a non-limiting example, embodiments of the present disclosure can optimize insulation, optimize shading, optimize photovoltaic power production, or any other disclosed parameter. It should also be understood that various combinations of parameters can be combined and/or weighted to produce optimizations accounting for multiple parameters.

As shown in FIGS. 2-7, embodiments of the present disclosure can include different configurations of shades. A non-limiting example system 200 including movable shades 202a, 202b is illustrated in FIG. 2. The movable shades 202a, 202b in FIG. 2 have been applied to the outdoor side of a window 204 having a width of W_{w} and a height of H. As shown in FIG. 2, the insulated shades 202a, 202b can be formed using insulated panels each with a width, Wₛ, and a height, Hₛ, that can slide along the rails 206 placed on top and bottom of the window. Wheels 208 can also be attached to the movable shades 202a, 202b or to the rails 206 to allow the movable panels 202a, 202b to be rolled along the rails 206.

The position of the movable shades 202a, 202b can be determined by the parameter, d, that can represent the separation distance between the movable shade 202a and the movable shade 202b. When d=0, the movable shade 202a and the movable shade 202b can be considered to be in the fully closed position with the window 204 totally shaded. As the panels slide away from the center of the window (i.e., 0<d<W_{w}), the shade is partially closed/open resulting in a partially shaded window. When d≥W_{w}, the panels can be considered to be in the fully open position with the window completely unshaded.

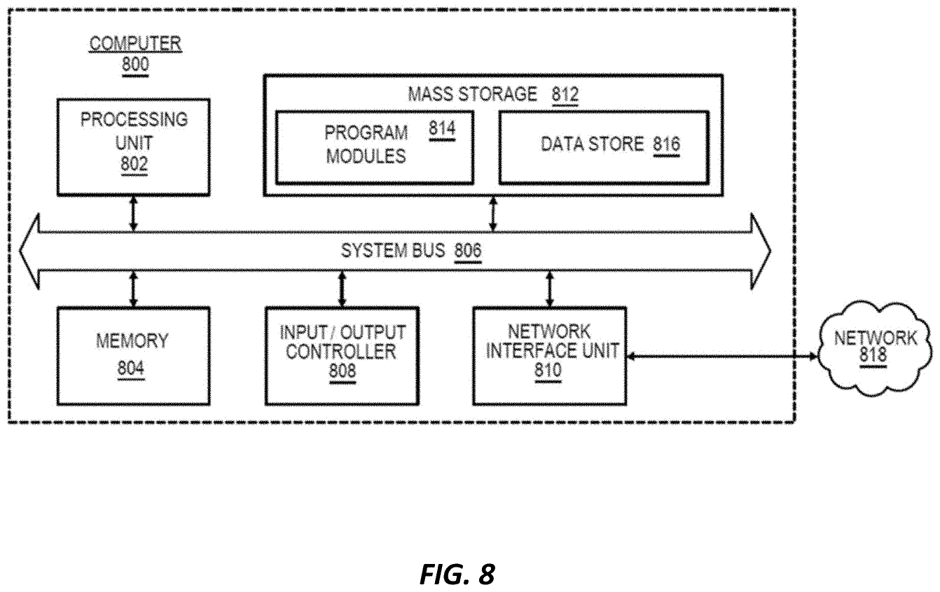

In some embodiments of the present disclosure, the distance d between the two movable shades 202a, 202b can be adjusted to any position varying from any extreme distances including d=0 to d=W_{w} using hourly, daily, or monthly setting frequency. The use of any other frequencies of adjustment is contemplated by the present disclosure. The system 200 can be controlled using a controller 210, which can include one or more computing devices (e.g., the computer 800 described with reference to FIG. 8). The controller 210 can be operatively connected to an antenna 220 that can transmit and/or receive information related to the control and status of the movable shades 202a, 202b.

It should be understood the present disclosure contemplates that the movable shades can be movable along any axis. For example, it should be understood that the panels depicted in FIGS. 2-7 can move vertically along the surface of the window 204, or diagonally along the window surface. It should also be understood that any geometries of movable shade 202a, 202b can be used. For example, the movable shades can be shapes other than rectangles.

In the embodiment of the present disclosure illustrated in FIG. 2, the movable shades 202a, 202b do not include photovoltaic panels. The present disclosure contemplates that photovoltaic elements (e.g., solar panels) can be added to a surface of the movable shade. FIG. 3A illustrates movable panels with photovoltaic elements 302a, 302b. In FIG. 3A, the photovoltaic panels are fixed in position relative to the movable shade.

In other embodiments of the present disclosure, the photovoltaic panel(s) are movable relative to the movable shade as shown in FIG. 3B. In the embodiment of the present disclosure shown in FIG. 3B, photovoltaic elements 354a, 354b can be attached to a movable shade 202a 202b. The photovoltaic elements 354a, 354b can tilt relative to the movable shades 202a 202b forming an angle θ between the movable shades 202a, 202b and the photovoltaic elements 354a, 354b. But it should be understood that the photovoltaic elements 354a, 354b can move in any dimension/axis relative to the movable shades 202a, 202b.

The photovoltaic elements 354a, 354b added to the movable shade can have a width Wp, and depth, dₚ, as indicated in FIG. 3B. These photovoltaic elements 354a, 354b can be static with the tilt set at any specific tilt angle, θ, or dynamic with the tilt angle varied on hourly, daily, or monthly basis. When the photovoltaic is fixed on the surface of the movable shade (e.g., lying flat against the surface of the movable shade 202a, 202b), 0 can be considered as 0 degrees, as illustrated in FIG. 3A.

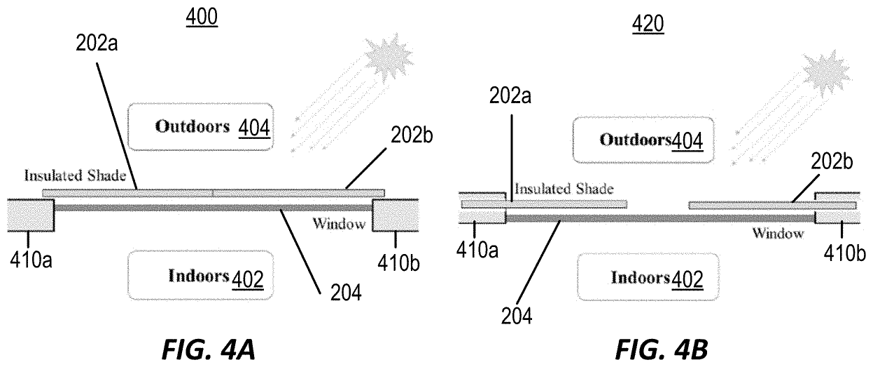

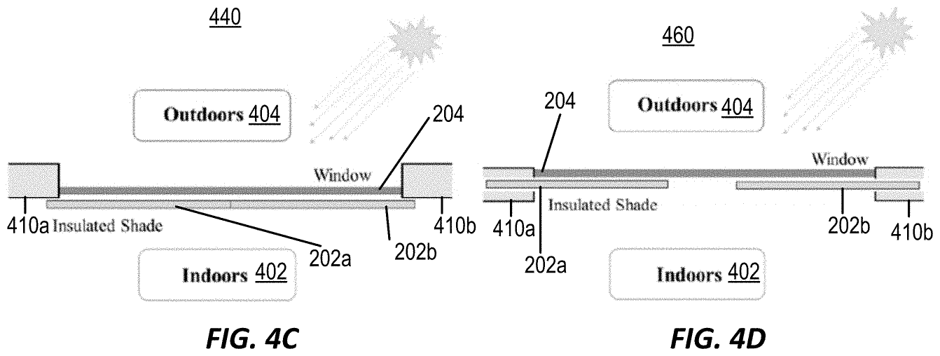

It should also be understood that the movable shades can be positioned in different parts of the structure/window, and that the positions of the shades in FIGS. 2-7 are for illustration only. Non-limiting examples of potential ways that shades can be attached to windows/structures are shown in FIGS. 4A-4D. Several configurations can be considered for the sliding shades depending on the relative position of the sliding rails and the window as indicated by the wall-window sections of FIGS. 4A-4D. FIGS. 4A-4D illustrate different configurations of movable shades 202a, 202b relative to a window 204, where the indoor side 402 and outdoor side 404 are shown.

The case of external shades 400 of is shown in FIG. 4A. In FIG. 4A a first configuration 400 is shown where the movable shades 202a, 202b are on the outdoor side 404 of the window 204. The movable shades 202a, 202b are outside the walls 410a, 410b of the structure, and slide along the outdoor side 404.

In FIG. 4B, a second configuration 420 is shown, where the movable shades 202a, 202b are configured to slide inside the walls 410a, 410b, and the movable shades 202a, 202b are on the outdoor side 404. Optionally, the second configuration 420 illustrated in FIG. 4B can be implemented by adding rails (not shown) inside the walls 410a, 410b.

In FIG. 4C, a third configuration 440 is shown, where the movable shades 202a, 202b are on the indoor side 402. Optionally, the third configuration 440 can be implemented by adding rails (not shown) to the indoor side 402 of the walls 410a, 410b.

In FIG. 4D, a fourth configuration 460 is shown where the movable shades 202a 202b are on the indoor side 402 and configured to slide inside the walls 410a, 410b. Optionally, the fourth configuration 460 can be implemented by inserting rails within the walls 410a, 410b.

While the configurations for FIG. 4B and FIG. 4D allow for hiding the shades when they are in partially or fully open positions, they can be suitable for new construction or replacement of windows.

FIG. 4A and FIG. 4C can be readily deployed for existing buildings with minimal implementation costs. The present disclosure includes information about the energy performance of static and dynamic external shades of configuration of FIG. 4B that was evaluated for US apartment units. This configuration can offer the benefits of integrating PV panels their outside surface directly or through titled supports and thus further enhance their energy efficiency benefits. It should be understood that other configurations will become apparent to those of skill in the art, and that similar mounting techniques can be used to allow the shades to be movable in the vertical or other directions.

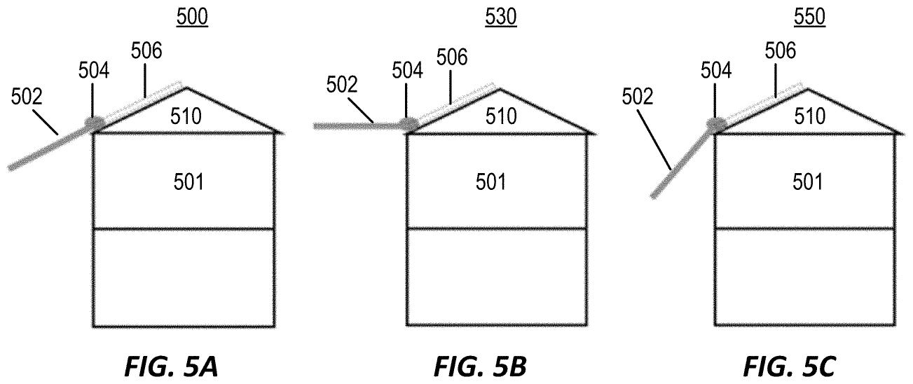

It should also be understood that the photovoltaic elements can be mounted above the window, and configured to tilt and shade the window, as shown in FIGS. 5A-5C. FIGS. 5A-5C illustrate embodiments of the present disclosure that can be positioned on a roofline and deployed to partially or completely shade either the roofline or one or more windows below the roofline.

FIGS. 5A-5C illustrate a building 501 with a roofline 510. The roofline 510 includes a movable shade 502 that can rotate around an axis of rotation 504. The movable shade 502 can slide and/or rotate to different positions relative to the roofline 510. For example, in the first configuration 500 shown in FIG. 5A, the movable shade 502 can be deployed from a first position 506 on the roof to shade the building 501. The shade 502 can be deployed by any combination of sliding and/or rotation relative to the axis of rotation 504. In some embodiments, the axis of rotation can include one or more hinges, rails, motors, and/or other mechanisms configured to move the movable shade 502.

FIG. 5B illustrates a second configuration 530 for the movable shade 502, and FIG. 5C illustrates a third configuration 550 of the movable shade 502. The configurations 500, 530, 550 illustrated in FIGS. 5A-5C can have different effects. For example, depending on the position of the movable shade, the amount of shading to the building 501 or roofline 510 can be altered. As another example, if the movable shade 502 includes photovoltaic elements, then each of the configurations 500, 530, 550 may produce different amounts of electrical energy, depending on the position of the sun relative to the building 501 and the movable shade 502. As yet another example, if the movable shade 502 includes insulation, the different configurations 500, 530, 550 may add different amounts of insulation to the building 501 or roofline 510.

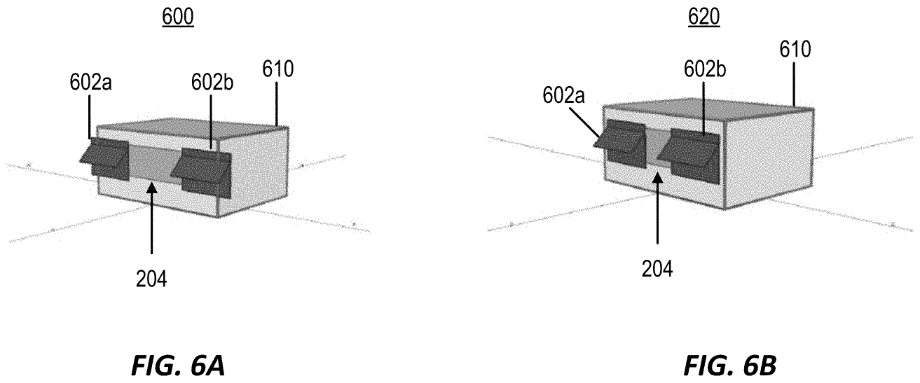

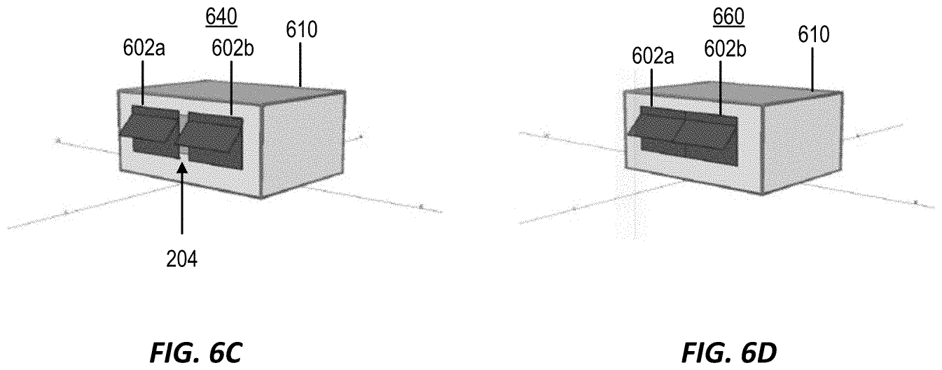

With reference to FIG. 6A-6D, some embodiments of the present disclosure include movable shades with tilted photovoltaic panels (i.e., photovoltaic elements). FIG. 6A shows a first configuration 600 including a first movable shade with tilted photovoltaic panel 602a and a second movable shade with a tilted photovoltaic panel 602b on opposite sides of a window 204 in a wall of a building 610. FIG. 6B shows a second configuration 620 where the first movable shade with tilted photovoltaic panel 602a and the second movable shade with tilted photovoltaic panel 602b have been moved closer together so that more of the window is shaded (as compared to the configuration 600 in FIG. 6A).

FIG. 6C shows a third configuration 640 where the first movable shade with tilted photovoltaic panel 602a and the second movable shade with tilted photovoltaic panel 602b have been moved closer together so that more of the window is shaded (as compared to the configuration 620 in FIG. 6B).

FIG. 6D shows a fourth configuration 660 where the first movable shade with tilted photovoltaic panel 602a and the second movable shade with tilted photovoltaic panel 602b are positioned to cover the window completely. It should be understood that the first movable shade with tilted photovoltaic panel 602a and the second movable shade with tilted photovoltaic panel 602b can be at any position relative to each other and the window, and the example configurations 600, 620, 640, 660 shown in FIGS. 6A-6D are intended only as non-limiting examples.

Embodiments of the present disclosure can be controlled by automated controls (e.g., using the computer 800 illustrated in FIG. 8). As described herein with reference to FIGS. 2-7, movable shades can include different combinations of insulation and photovoltaic elements. The movable shades can also be formed in different shapes and sizes, and be configured to move to different positions and orientations. Therefore, different positions and orientations of the movable shades can produce different combinations of electrical energy (from any photovoltaic elements), shading, and insulation (from any insulation that is part of the movable shades). The relationship between the different effects of the movable shades can be represented by a cost function. For example, the cost function can include weighted values for the effects of insulation, shading, and electrical energy production. For example, the effects of insulation, shading, and electrical energy production can be represented as functions of the positions of the one or more movable shades on a building. As a non-limiting example, the cost function can represent total annual energy consumption of the building, and the inputs to the cost function can represent how shading, electrical energy production, and insulation affect the overall annual energy consumption of the building. Therefore, minimizing the cost function that represents the total annual energy consumption of the building can include determining the positions of the movable shades on the building that will minimize the total annual energy consumption for the building.

Automated controls can allow embodiments of the present disclosure to minimize the total annual energy consumption of a building as well as to achieve other desired cost functions by controlling the position and orientation of the movable shades. Non-limiting examples of other cost functions include higher thermal comfort levels and/or lower electrical peak demand. Moreover, pre-defined schedules can be used for seasonal and monthly position settings of the shades. Embodiments of the present disclosure can implement control strategies that operate the sliding shades using different time intervals, including monthly, daily, and hourly operation frequency.

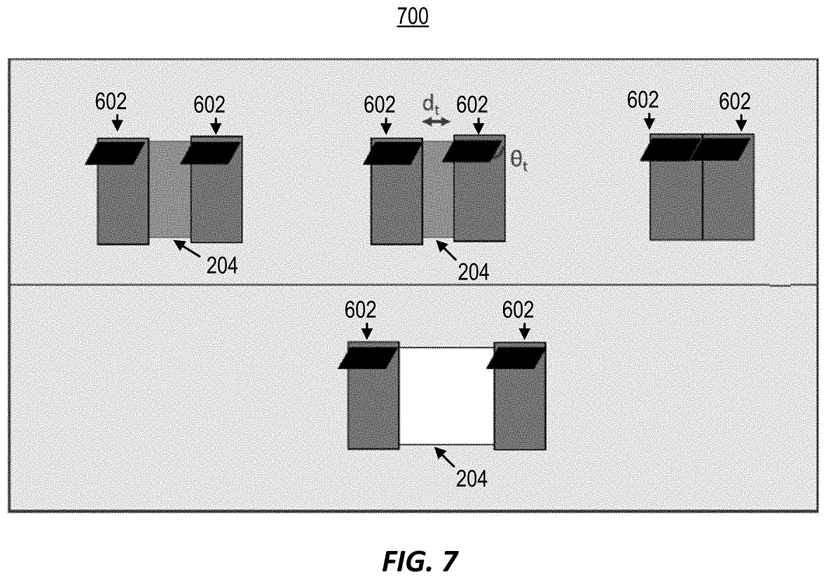

With reference to FIG. 7, multiple movable shades with photovoltaic panels 602 are shown around multiple windows 204. As shown in FIG. 7, the movable shades with photovoltaic panels 602 can be independently controlled for each window 204, so that in a building 700 with multiple windows 204 and multiple movable shades with photovoltaic panels 602, each of the windows 204 can be shaded by a different amount. It should be understood that the movable shades with photovoltaic panels illustrated in FIG. 7 are only non-limiting examples, and any of the movable shades described herein can be independently controlled.

Non-limiting examples of control strategies that can be used in embodiments of the present disclosure include “Cont: dₘᵢₙ-dₘₐₓ,” and “Step: dₘᵢₙ-dₘₐₓ.” In Cont: dₘᵢₙ-dₘₐₓ, the distance, d, separating the two panels as depicted in FIG. 2 to be set continuously at any value between two extremes positions d=dₘᵢₙ and d=dₘₐₓ. Thus, Cont:0-3.8-m: allows the full range for the positions of the shades for a window having a width of W_{w}=3.8-m between d=0-m (completely closed) resulting in totally shaded window and d=3.8-m (fully open) which is equivalent to the baseline option with no external shades. Using Step: dₘᵢₙ-dₘₐₓ, the shades are limited to two positions, either d=dₘᵢₙ or d=dₘₐₓ, simplifying the controls as well as the required motion mechanisms. Thus, Step: 1.4-3.8-m indicates that the shades can be set either at d=1.4-m (partially closed) or d=3.8-m (fully open) for a 3.8-m wide window.

It should be understood that these control strategies are only examples and that embodiments of the present disclosure can include models and control strategies based on other control strategies. Embodiments of the present disclosure allow for any position to be considered between two extreme distances. Moreover, the optimal positions can be determined throughout the analyses in order to minimize HVAC energy end-use and ultimately the annual building energy consumption or any other parameter.

Embodiments of the present disclosure can use a distinct building energy modeling (DBEM) approach. In this approach, the energy performance can be determined through modeling of static shades using all the considered discrete positions and then selecting on monthly basis the position that provides the lowest building energy use. Due to the thermal inertia associated with the building envelope systems, DBEM can be unsuitable for daily and hourly adjustments of the shades' position. Alternatively or additionally, the parametric behavior map (PBM) approach can be considered using shading schedules for both solar transmission and U-values to model the effects of varying the position of the shades as detailed by other studies for dynamic shading systems. For PBM modeling technique, equivalent shading schedules are defined for solar transmission and U-values to model the effects of varying the position of the shades as detailed in other studies for dynamic shading systems. The best sets of shading schedules are then determined to minimize the thermal loads of the housing unit.

The DBEM and PBM approaches can be combined. As a non-limiting example, embodiments of the present disclosure can use the DBEM approach for monthly settings and use DBEM for daily and hourly settings because in some embodiments of the present disclosure DBEM can be suitable for identifying optimal tilt angles for the PV panels, but can be less suitable in some implementations for determining the best positions for the shades due to thermal inertia of the housing unit affecting it's the time variation of heating and cooling thermal loads. In these embodiments, the parametric behavior map (PBM) technique can be used to determine the optimal positions for the shades on daily and hourly bases. In the DBEM modeling approach, the energy performance can be determined through comparing the results obtained for static shades using all the discrete positions by selecting the monthly positions that provide the minimal energy demand.

In some embodiments of the present disclosure, the tilt angle, θ, for PV panels can be controlled independently from the shade position to maximize the annual PV generation output. It should be understood that the shades and PV panels of the present disclosure can be set continuously at any desired positions (both in position and angle relative to the building and one another). Moreover, while embodiments disclosed herein refer to the optimal positions are minimizing the annual building energy demand to account for both the reduction in HVAC thermal loads and the PV on-site electricity generation, it should be understood that objective functions can be considered top optimally control the PV-integrated dynamic shades such as lower electrical peak demand.

Embodiments of the present disclosure relate to low-cost PV-integrated dynamic shades that can be used for any type of building. Some non-limiting examples of buildings where the low-cost PV-integrated dynamic shades can be used include apartment units/buildings, detached homes, office buildings and hotels. These shades can provide both energy efficiency and renewable energy benefits for fenestration facades including enhance management of solar heat gains as well as thermal heat transmissions and provide support for static and tracking PV panels. The dynamic shades and control methods disclosed herein can allow decoupled operations and controls of energy efficiency benefits and of on-site PV generation.

Motors, Actuators, and Controllers

In accordance with various embodiments of the present disclosure described herein, a movable shade, including MPVISD's can use one or more of AC and DC motors, as well as actuators, connected to a controller, to operate the various example implementations and aspects discussed herein. The controller can perform such operation according to a set of rules and/or through scheduled settings. The same or different motors can be used to drive the sliding and rotation movements. The movable shade or MPVISD can be separate (i.e., a standalone system) or integrated with the PV panels.

The sliding movement can be also achieved by placing of the PV panels into rails (as shown in FIGS. 4A-4D) with wheels, configured such that the movement can be completed through a motor and/or manually. Similarly, the rotation along any of the axes can be automatic (i.e., with motorized actuators) or manual.

Various functionalities are described herein with respect to a “controller” that determines or otherwise controls certain functional aspects of some embodiments of the present disclosure. The “controller” may be a programmable computer configured to execute instructions such that the functions are performed in a system.

For example, a “controller” may utilize one or more aspects and/or components of a computing system as described as follows. FIG. 8 is a computer architecture diagram showing a general computing system capable of implementing one or more embodiments of the present disclosure described herein. A computer 800 may be configured to perform one or more functions associated with embodiments illustrated in one or more of FIGS. 1-7. It should be appreciated that the computer 800 may be implemented within a single computing device or a computing system formed with multiple connected computing devices. For example, the computer 800 may be configured for a server computer, desktop computer, laptop computer, or mobile computing device such as a smartphone or tablet computer, or the computer 800 may be configured to perform various distributed computing tasks, which may distribute processing and/or storage resources among the multiple devices.

As shown, the computer 800 includes a processing unit 802, a system memory 804, and a system bus 806 that couples the memory 804 to the processing unit 802. The computer 800 further includes a mass storage device 812 for storing program modules. The program modules 814 may include modules executable to perform one or more functions associated with embodiments illustrated in one or more of FIGS. 1-7. The mass storage device 812 further includes a data store 816.

The mass storage device 812 is connected to the processing unit 802 through a mass storage controller (not shown) connected to the bus 806. The mass storage device 812 and its associated computer storage media provide non-volatile storage for the computer 800. By way of example, and not limitation, computer-readable storage media (also referred to herein as “computer-readable storage medium” or “computer-storage media” or “computer-storage medium”) may include volatile and non-volatile, removable and non-removable media implemented in any method or technology for storage of information such as computer-storage instructions, data structures, program modules, or other data. For example, computer-readable storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 800. Computer-readable storage media as described herein does not include transitory signals.

According to various embodiments, the computer 800 may operate in a networked environment using connections to other local or remote computers through a network 818 via a network interface unit 810 connected to the bus 806. The network interface unit 810 may facilitate connection of the computing device inputs and outputs to one or more suitable networks and/or connections such as a local area network (LAN), a wide area network (WAN), the Internet, a cellular network, a radio frequency network, a Bluetooth-enabled network, a Wi-Fi enabled network, a satellite-based network, or other wired and/or wireless networks for communication with external devices and/or systems.

The computer 800 may also include an input/output controller 808 for receiving and processing input from a number of input devices. Input devices may include, but are not limited to, keyboards, mice, stylus, touchscreens, microphones, audio capturing devices, or image/video capturing devices. An end user may utilize such input devices to interact with a user interface, for example a graphical user interface on one or more display devices (e.g., computer screens), for managing various functions performed by the computer 800, and the input/output controller 808 may be configured to manage output to one or more display devices for visually representing data. The bus 806 may enable the processing unit 802 to read code and/or data to/from the mass storage device 812 or other computer-storage media. The computer-storage media may represent apparatus in the form of storage elements that are implemented using any suitable technology, including but not limited to semiconductors, magnetic materials, optics, or the like. The program modules 814 may include software instructions that, when loaded into the processing unit 802 and executed, cause the computer 800 to provide functions associated with embodiments illustrated in FIGS. 1-7. The program modules 814 may also provide various tools or techniques by which the computer 800 may participate within the overall systems or operating environments using the components, flows, and data structures discussed throughout this description. In general, the program module 814 may, when loaded into the processing unit 802 and executed, transform the processing unit 802 and the overall computer 800 from a general-purpose computing system into a special-purpose computing system.

The processing unit 802 may be constructed from any number of transistors or other discrete circuit elements, which may individually or collectively assume any number of states. More specifically, the processing unit 802 may operate as a finite-state machine, in response to executable instructions contained within the program modules 814. These computer-executable instructions may transform the processing unit 802 by specifying how the processing unit 802 transitions between states, thereby transforming the transistors or other discrete hardware elements constituting the processing unit 802. Encoding the program modules 814 may also transform the physical structure of the computer-readable storage media. The specific transformation of physical structure may depend on various factors, in different implementations of this description. Examples of such factors may include, but are not limited to: the technology used to implement the computer-readable storage media, whether the computer-readable storage media are characterized as primary or secondary storage, and the like. For example, if the computer-readable storage media are implemented as semiconductor-based memory, the program modules 814 may transform the physical state of the semiconductor memory, when the software is encoded therein. For example, the program modules 814 may transform the state of transistors, capacitors, or other discrete circuit elements constituting the semiconductor memory.

As another example, the computer-storage media may be implemented using magnetic or optical technology. In such implementations, the program modules 814 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present disclosure.

Numerous characteristics and advantages provided by aspects of the present disclosure have been set forth in the foregoing description. The patentable scope of certain embodiments is set forth in the appended claims. While the present disclosure is disclosed in several forms herein, it will be apparent to those skilled in the art that many modifications can be made therein without departing from the spirit and scope of the present disclosure and its equivalents. Therefore, other modifications or embodiments as may be suggested by the teachings herein are particularly reserved.

What is claimed is:

1. A shade system for a building or house, comprising:
at least one moveable shade that is moveable in position about one or more of a lateral axis, vertical axis, and rotational axis with respect to a window of the building or house, wherein the at least one moveable shade is external to or internal to the window, and
a programmable controller configured to selectively control movement of the at least one moveable shade about the lateral axis, vertical axis, and/or rotational axis,
wherein the at least one moveable shade is selectively moveable to regulate conditions of the building or house based at least on one or more of incoming radiation, temperature, season, and time of day.

2. The shade system of claim 1, wherein the regulated conditions of the building or house comprise at least one of temperature and energy usage of the building or house.

3. The shade system of claim 1, wherein the at least one moveable shade is selectively moveable along the vertical axis of the window of the building or house.

4. The shade system of claim 1, wherein the at least one moveable shade is selectively moveable in the lateral axis along rails positioned at or on the respective window.

5. The shade system of claim 1, wherein the at least one moveable shade is selectively rotatable about the rotation axis such that the angular position of a rotatable panel portion, relative to the window, has a non-zero angular orientation and a non-zero tilt angle.

6. The shade system of claim 1, wherein the at least one moveable shade comprises at least one rotatable panel portion.

7. The shade system of claim 6, wherein the rotatable panel portion comprises one or more photovoltaic elements.

8. The shade system of claim 6, wherein the rotatable panel portion is configured as an overhang.

9. The shade system of claim 1, wherein the at least one moveable shade comprises one or more layers of insulation.

10. The shade system of claim 1, wherein the at least one moveable shade comprises at least two moveable shades, the at least two moveable shades comprising a first moveable shade and a second moveable shade, and wherein the first moveable shade and the second moveable shade are selectively moveable along at least the lateral axis with respect to one another such that the first moveable shade and the second moveable shade cover some or all of the window.

11. The shade system of claim 10, wherein the programmable controller is configured to selectively move the first moveable shade and second moveable shade.

12. A method of shading at least part of a building or house, comprising:
selectively moving, using a programmable controller, the position of at least one moveable shade along one or more of a lateral axis, vertical axis, and rotational axis with respect to a window of the building or house, to regulate conditions of the building or house based on at least one of incoming radiation, temperature, season, and time of day.

13. The method of claim 12, further comprising selectively moving, using the programmable controller, the at least one moveable shade along the vertical axis of the window of the building or house.

14. The method of claim 12, further comprising selectively moving, using the programmable controller, the at least one moveable shade to rotate about the rotational axis such that the angular position of a rotatable panel portion, relative to the window, has a non-zero angular orientation and non-zero tilt angle.

15. The method of claim 12 wherein the at least one moveable shade comprises at least one panel portion comprising at least one photovoltaic element.

16. The method of claim 12, wherein the at least one moveable shade comprises at least one panel portion comprising one or more layers of insulation.

17. The method of claim 12, wherein the regulated conditions of the building or house comprise at least one of temperature and energy usage of the building or house.

18. The method of claim 12, wherein the at least one moveable shade comprises at least two moveable shades, the at least two moveable shades comprising a first moveable shade and a second moveable shade, and wherein the first moveable shade and the second moveable shade are selectively moveable, using the programmable controller.

19. The method of claim 18, further comprising changing, using the programmable controller, at least the vertical position and the rotation angle of the at least one moveable shade.
